(19) United States
(12) Patent Application Publication
(10) Pub. No.: US 2010/0308789 A1
(43) Pub. Date: Dec. 9, 2010

(54) BAND GAP REFERENCE VOLTAGE GENERATOR

(75) Inventors: Sung-ho Beck, Seongnam-si City (KR); Seong-heon Jeong, Seoul City (KR)

Correspondence Address: AUSTIN RAPP & HARDMAN, 170 South Main Street, Suite 735, SALT LAKE CITY, UT, 84101, US

(73) Assignee: Silicon Motion, Inc., Tianan Digital City (CN)

(21) Appl. No.: 12/745,532

(22) PCT Filed: Jun. 8, 2009
(86) PCT No.: PCT/CN09/72177

§ 371 Date: May 28, 2010

(30) Foreign Application Priority Data
Jun. 9, 2008 (KR) 10-2008-0053457

(51) Int. Cl. G05F 3/16

(52) U.S. Cl. 323/313

(57) ABSTRACT

A band gap reference voltage generator with low working voltage is disclosed. The band gap reference voltage generator can stably operates that the unexpected balance status does not occur due to the manufacturing process inaccuracy or the offset voltage. The band gap reference voltage generator comprises a thermal voltage generation circuit, a voltage level optimizing circuit and a band gap reference voltage generating circuit. The thermal voltage generating circuit provides a first voltage and a second voltage. The first voltage is for generating a current component increased with temperature rising. The second voltage is for generating a current component decreased with temperature rising. The voltage level optimizing circuit optimizes the voltage level of the second voltage to generate a third voltage. The band gap reference voltage generating circuit generates the reference voltage with a specific voltage level corresponding to the first voltage and the third voltage irrelevant with the temperature.

### BACKGROUND OF THE INVENTION

1. Field of the Invention

The present invention generally relates to a reference voltage generator, and more particularly to a band gap reference voltage generator.

2. Description of Prior Art

A band gap reference voltage generator utilizes a band gap voltage of silicon in a silicon based IC to generate a reference voltage irrelevant with the manufacturing process, the temperature and apply voltage.

FIG. 1 shows a concept of a reference voltage generator. The reference voltage generator generates a reference voltage with a specific voltage level and irrelevant with the temperature.

Please refer to FIG. 1. The reference voltage generator counteracts the proportional to absolute temperature voltage (PTAT) and base-emitter voltage (Vbe) of the bipolar transistor which decreases with the temperature rising to generate a reference voltage (BVR) which is slow-response to the temperature.

Please refer to FIG. 2, which depicts a circuit diagram of a band gap reference voltage generator of prior art. A general reference voltage generator (200) is shown in FIG. 2. The simple working theory is introduced hereafter.

The general reference voltage generator 200 comprises three MOSFETs M1, M2, and M3, three bipolar transistors Q1, Q2, and Q3, two resistors R1, R2 and an operational amplifier OP. The operational amplifier OP is coupled as to form a negative feedback circuit. Therefore, the voltage levels Va, Vb of the two input ends are equal. Assuming that a size of the first bipolar transistor Q1 is m times of a size of the second bipolar transistor Q2 and the Kirchhoff's Current Law is applied for the first resistor R1, the first bipolar transistor Q1 and the second bipolar transistor Q2. The first current I1 can be represented by equation 1:

$${I}_{1} = \frac{{V}_{T}}{{R}_{1}} ln m \qquad ( eq . 1 )$$

The V_{T} represents the thermal voltage. The value of the thermal voltage in room temperature is about 25 mV and increases with the temperature rising. The output voltage Vout of the reference voltage generating circuit 100 can be represented by equation 2:

$${V}_{out} = \frac{{R}_{2}}{{R}_{1}} {V}_{T} ln m + {V}_{be 3} \qquad ( eq . 2 )$$

Please refer to the equation 2. The output voltage Vout of the general reference voltage generator 200 is the sum of the voltage drop (R2×I1) of the current I1 of the third MOSFET M3 which occurs at the second resistor R2 and the base-emitter voltage Vbe3 of the third bipolar transistor Q3. The first item at the right side of the equal sign is a voltage proportional to the temperature rising. The base-emitter voltage Vbe is a voltage inverse proportional to the temperature rising. With proper adjustments to the item proportional to the temperature rising and the item inverse proportional to the temperature rising, the output voltage Vout can be a voltage which is irrelevant with the temperature, a reference voltage with a voltage level, which the temperature coefficient is 0. The voltage level of the reference voltage is decided by the characteristic of the silicon wafer for manufacturing the MOSFETs and the bipolar transistors, which is about 1.2V (volts).

For realizing the miniaturization of the semiconductor manufacture and increasing the reliability, the low power cost of the IC, the preferable solution is to drop the working voltage of the system. Recently, 1.2V voltage is a main selection for the 90 nm (nano meter) process. In accordance with the smaller pitch, as 65 nm, 40 nm, the working voltage of the system is dropped to 0.9V, 0.6V. The present circuit as shown in FIG. 1 cannot generates the reference voltage lower than 1.2V with the apply voltage lower than 1.2V.

The present technology related with the reference voltage generation with the apply voltage lower than band gap voltage can be found in the paper (K. N. Leung and K. T. Mok, “A sub 1-V 15-ppm/C CMOS bandgap reference without requiring low threshold voltage device,” IEEE Journal of Solid-State Circuits, vol. 37, pp. 526-529, April 2002).

FIG. 3 depicts a circuit diagram of a low voltage band gap reference voltage generator of prior art. Please refer to FIG. 3. The reference voltage Vout can be represented by equation 3:

$${V}_{out} = \frac{{R}_{4}}{{R}_{1}} ( {V}_{be 2} + \frac{{R}_{1}}{{R}_{3}} \frac{kT}{q} ln m ) , \\ R 1 = R 1 a + R 1 b = R 2 a + R 2 b \qquad ( eq . 3 )$$

The working theory of the low voltage band gap reference voltage generator, shown in FIG. 3 is introduced hereafter.

For constructing the power supply representing the reference voltage Vout in equation 3, the term increased with the temperature rising is generated by two bipolar transistors Q1, Q2 and the third resistor R3. The operational amplifier OP makes Va and Vb equal. When the ratio of the two resistors, i.e. R1a:R1b and R2a:R2b are equal, Va3 and Vb3 become equal, too. As the Kirchhoff's Current Law is applied for R3, Q1 and Q2, the PTAT current similarly shown in FIG. 2 is generated. Beside, the current of the Vbe2/(R2a+R2b) is generated by the R2a, R2b and Q2. The generated PTAT current and the Vbe current are merged at M2 and then via M3 generate a voltage at R4. At this moment, once the value of R4 is smaller, the final band gap voltage can be lower than 1.2V and therefore to achieve a low working voltage.

However, the band gap reference voltage generator 300 shown in FIG. 3 may have some issue for start up. In the band gap reference voltage generator 300 in FIG. 3, two input ends of the operational amplifier OP are virtual grounded. This is the reason why Va and Vb are equal. In the balance status, an output voltage Vout represented in equation 3 can be generated. However, an undesired balance status, i.e. the status that no current I1 flows (I1=0) can happen.

FIG. 4 shows a diagram of a simulation experiment result of the reference voltage generator shown in FIG. 3. Please refer to FIG. 4. FIG. 4. is a experiment result in accordance with increase of the internal current I1 inside the circuit. The balance status is when the voltages Va, Vb of the two ends of the operational amplifier OP are equal. In FIG. 4, the desired balance status is when I1=16 μA (micro ampere) and the undesired balance status is when I1=0 μA. Because the system cannot work in the undesired balance status is when I1=0 μA, an activation circuit is employed to prevent the status I1=0 μA. In the reference voltage generator shown in FIG. 3, the difference between the voltages Va, Vb at the input ends of the operational amplifier OP is not large, the undesired balance status due to offset voltage of the operational amplifier OP and etc can easily occur.

The reason why the difference between the voltages Va, Vb at the input ends of the operational amplifier OP is so small is that the equivalent resistances of the two bipolar transistors Q1, Q2 increase exponentially with smaller currents. Therefore, the voltages Va, Vb at the input ends of the operational amplifier OP are decided by every two series resistors R1a, R1b, R2a, R2b at this moment and the equivalent resistances of the two bipolar transistors Q1, Q2 take no effects thereto.

### SUMMARY OF THE INVENTION

An objective of the present invention is to provide a band gap reference voltage generator that can stably operates that the unexpected balance status does not occur due to the manufacturing process inaccuracy or the offset voltage.

The band gap reference voltage generator of the present invention comprises a thermal voltage generation circuit, a voltage level optimizing circuit and a band gap reference voltage generating circuit. The thermal voltage generating circuit provides a first voltage and a second voltage. The first voltage is for generating a current component increased with temperature rising. The second voltage is for generating a current component decreased with temperature rising. The voltage level optimizing circuit optimizes the voltage level of the second voltage to generate a third voltage. The band gap reference voltage generating circuit generates a reference voltage with a specific voltage level corresponding to the first voltage and the third voltage irrelevant with the temperature.

The merit of the band gap reference voltage generator is to have a stable operation that the unexpected balance status does not occur due to the manufacturing process inaccuracy or the offset voltage.

### BRIEF DESCRIPTION OF THE DRAWINGS

FIG. 1 shows a concept of a reference voltage generator, wherein the reference voltage generator generates a reference voltage with a specific voltage level and irrelevant with the temperature.

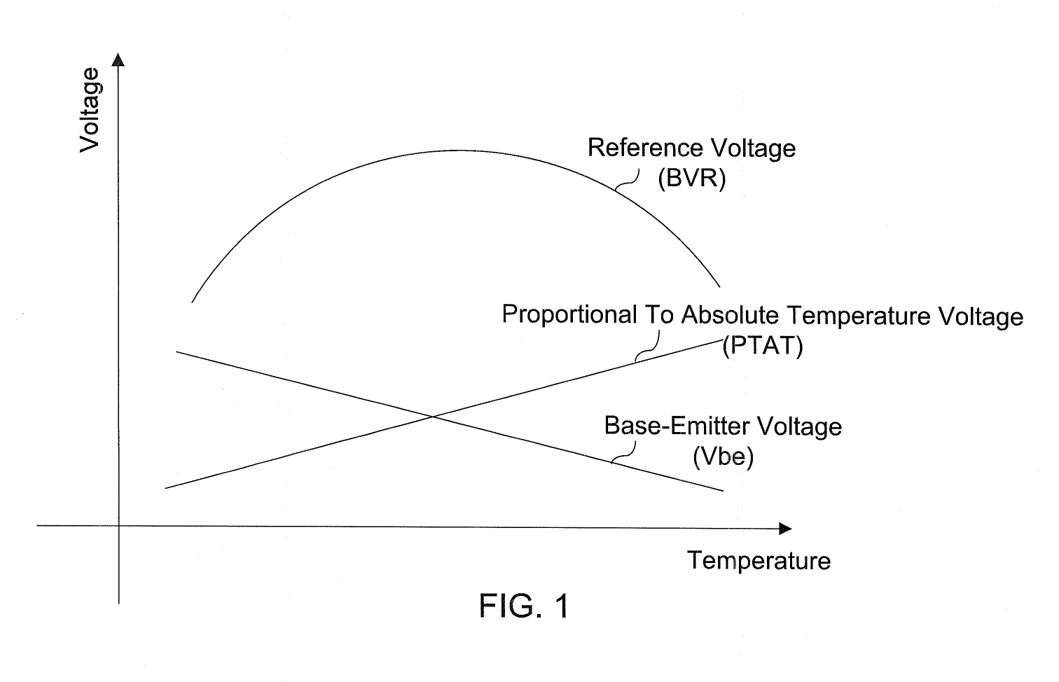

FIG. 2 depicts a circuit diagram of a band gap reference voltage generator of prior art.

FIG. 3 depicts a circuit diagram of a low voltage band gap reference voltage generator of prior art.

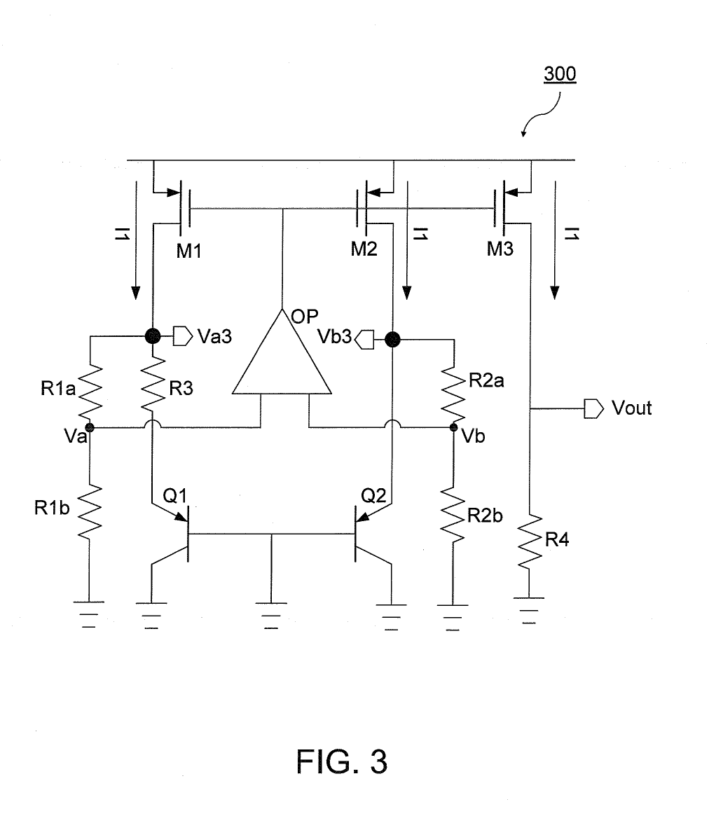

FIG. 4 shows a diagram of a simulation experiment result of the reference voltage generator shown in FIG. 3.

FIG. 5 depicts a circuit diagram of a low voltage band gap reference voltage generator of the present invention.

FIG. 6 shows a diagram a simulation experiment result of the reference voltage generator shown in FIG. 2.

### DETAILED DESCRIPTION OF THE INVENTION

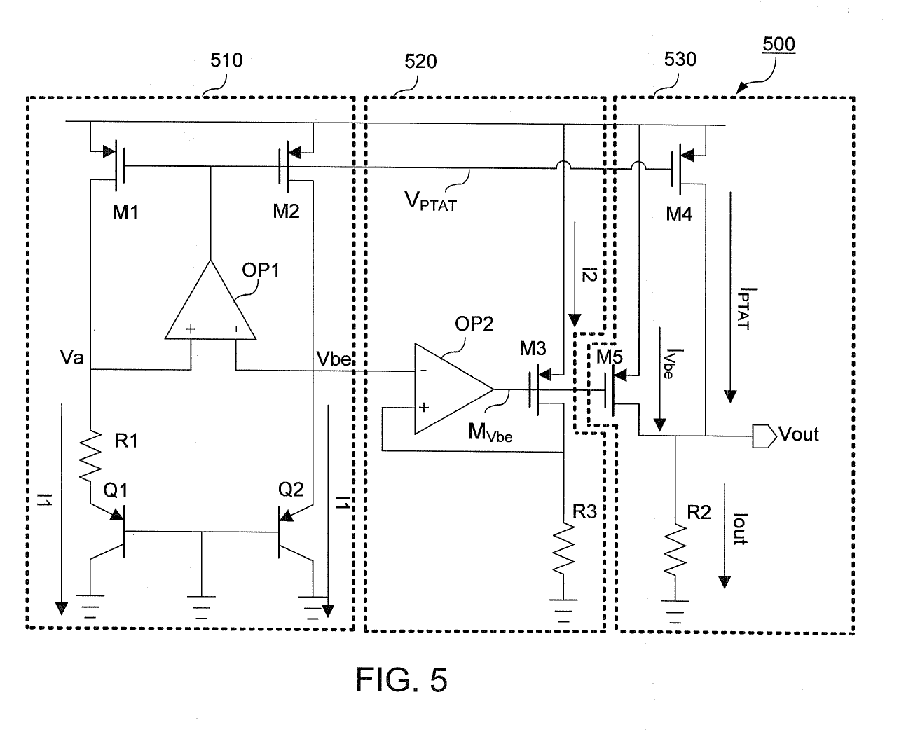

Please refer to FIG. 5, which depicts a circuit diagram of a low voltage band gap reference voltage generator of the present invention. A band gap reference voltage generator 500 comprises a thermal voltage generation circuit 510, a voltage level optimizing circuit 520 and a band gap reference voltage generating circuit 530.

The thermal voltage generating circuit 510 generates and provides a first voltage V_{PTAT} and a second voltage Vbe. The first voltage V_{PTAT} is employed for generating a current component increased with temperature rising. The second voltage Vbe is for generating a current component decreased with temperature rising. The thermal voltage generation circuit 510 comprises two MOSFETs M1, M2, two bipolar transistors Q1, Q2, a first operational amplifier OP1 and a first resistor R1. One end of the first MOSFET M1 is coupled to a first power supply. The gate of the first MOSFET M1 is applied with the first voltage V_{PTAT}. One end of the second MOSFET M2 is coupled to the first power supply. Corresponding to the first voltage V_{PTAT} applied to the gate of the second MOSFET M2, the second MOSFET M2 generates the second voltage Vbe at the other end thereof. One end of the first operational amplifier OP1 is coupled to the other end of the first MOSFET M1. The other end of the first operational amplifier OP1 is coupled to the other end of the second MOSFET M2. The first operational amplifier OP1 generates the first voltage V_{PTAT}. One end of the first resistor R1 is coupled to the one end of the first operational amplifier OP1. One end of the first bipolar transistor Q1 is coupled to the other end of the first resistor R1. The other end and the base terminal of the first bipolar transistor Q1 are coupled to a second power supply. One end of the second bipolar transistor Q2 is coupled to the other end of first operational amplifier OP1. The other end and the base terminal of the second bipolar transistor Q2 are coupled to the second power supply. Significantly, the size of the first bipolar transistor Q1 is m times of the size of the second bipolar transistor Q2 (m is a real number).

The voltage level optimizing circuit 520 optimizes a voltage level of second voltage Vbe and generates a third voltage MVbe. The voltage level optimizing circuit 520 comprises a second operational amplifier OP2, a third MOSFET M3 and a third resistor R3. The second operational amplifier OP2 outputs the third voltage MVbe corresponding to the second voltage Vbe which is applied to one end thereof. One end of the third MOSFET M3 is coupled to the first power supply. The other end of the third MOSFET M3 is coupled to the other end of the second operational amplifier OP2. The gate of the third MOSFET M3 is applied with the third voltage MVbe. One end of the third resistor R3 is coupled to the other end of the third MOSFET M3. The other end of the third resistor R3 is coupled to the second power supply.

The band gap reference voltage generating circuit 530 generates a reference voltage Vout with a specific voltage level corresponding to the first voltage V_{PTAT} and the third voltage MVbe. The reference voltage Vout is irrelevant with the temperature. The band gap reference voltage generating circuit 530 comprises a fourth MOSFET M4, a fifth MOSFET M5 and a second resistor R2. One end of the fourth MOSFET M4 is coupled to the first power supply. The fourth MOSFET M4 generates the reference voltage Vout corresponding to the first voltage V_{PTAT} applied to the gate thereof at the other end. One end of the fifth MOSFET M5 is coupled to the first power supply. The fifth MOSFET M5 generates the reference voltage Vout corresponding to the third voltage MVbe applied to the gate thereof at the other end. One end of the second resistor R2 is coupled to the other end of the fourth MOSFET M4 and the other end of the fifth MOSFET M5. The other end of the second resistor R2 is coupled to the second power supply.

Hereafter, introduced is the working theory of the reference voltage generator of the present invention shown in FIG. 5. As shown in FIG. 5, the thermal voltage generation circuit 510 generates the first voltage V_{PTAT} and the second voltage Vbe. The current component generated by the first voltage V_{PTAT} increases with temperature rising. The current component generated by the second voltage Vbe decreases with temperature rising.

The voltage level optimizing circuit 520 generates the third voltage MVbe. The third voltage MVbe is utilized for generates an optimized current component to counteract current component caused by the first voltage V_{PTAT} and changes the voltage level of the second voltage Vbe. In another word, the second operational amplifier OP2 applies the second voltage Vbe to the negative input end and feedbacks the voltage of the common dot of the third MOSFET M3 and the third resistor R3 to the positive input end to generate the optimized third voltage MVbe.

The internal current I1 of the thermal voltage generation circuit 510 can be represented as the same as equation 1. The internal current I2 of the voltage level optimizing circuit 520 can be represented by equation 4:

$${I}_{2} = \frac{{V}_{be}}{{R}_{3}} \qquad ( eq . 3 )$$

When the sizes of the second MOSFET M2 and the fourth MOSFET M4 which are both applied with the first voltage V_{PTAT} at the gates are equal, the current I1 flowing through the second MOSFET M2 and the I_{PTAT} flowing through the fourth MOSFET M4 also become equal. Similarly, when the sizes of the third MOSFET M3 and the fifth MOSFET M5 which are both applied with the third voltage M_{Vbe} at the gates are equal, the current I2 flowing through the third MOSFET M3 and the I_{Vbe} flowing through the fifth MOSFET M5 also become equal. Particularly, the definition of the sizes of the MOSFETs is the ratio W/L (Width/Length) of the gates.

The band gap reference voltage generating circuit 530 generates the reference voltage Vout. The reference voltage Vout comprises the voltage caused by the current I_{PTAT} flowing through the fourth MOSFET M4 and the voltage caused by the current I_{Vbe} flowing through the fifth MOSFET M5. The current I_{PTAT} is the current component increased with temperature rising and the current I_{Vbe} is the current component decreased with temperature rising. The reference voltage Vout can be represented by equation 5:

$${V}_{out} = \frac{{R}_{2}}{{R}_{3}} ( {V}_{be} + \frac{{R}_{2}}{{R}_{1}} {V}_{T} ln m ) \qquad ( eq . 5 )$$

Please refer to the above equation 5. comprises the item of the voltage Vbe, which increases with temperature rising and the item of the voltage V_{T} (=kT/q), which decreases with temperature rising. The two items are combined in a proper way. Therefore, even as working under a power supply with a lower voltage level, a band gap reference voltage with zero temperature coefficient generated by a voltage lower than 1 V can be achieved with proper adjustment to the resistances of the circuits.

As aforementioned, the reference voltage generator of the present invention is possibly functional without any problems. Moreover, the undesired balance status occurred to the reference voltage generator according to prior art will not occur to the reference voltage generator of the present invention shown in FIG. 5.

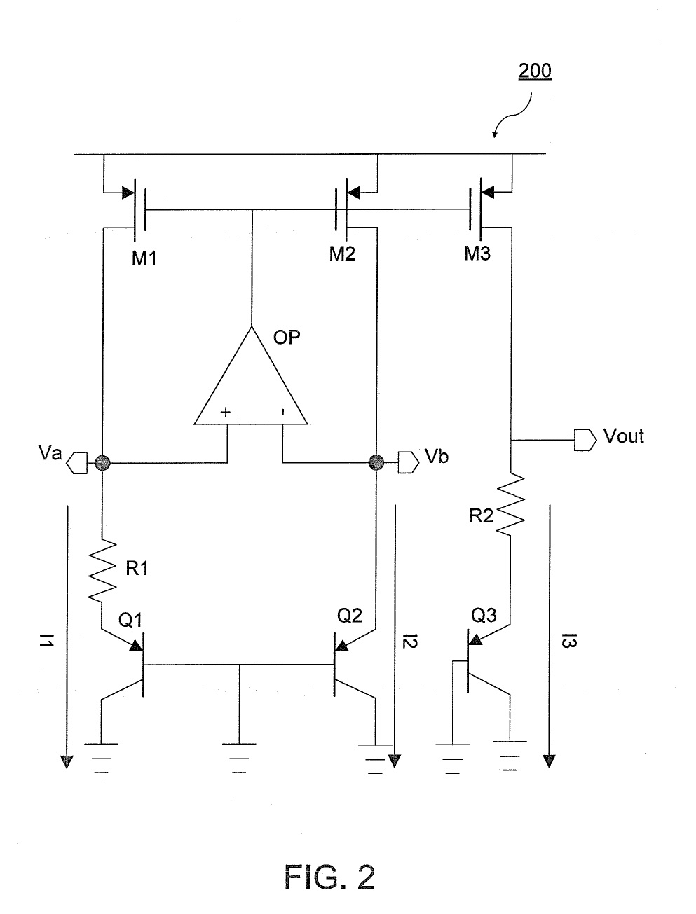

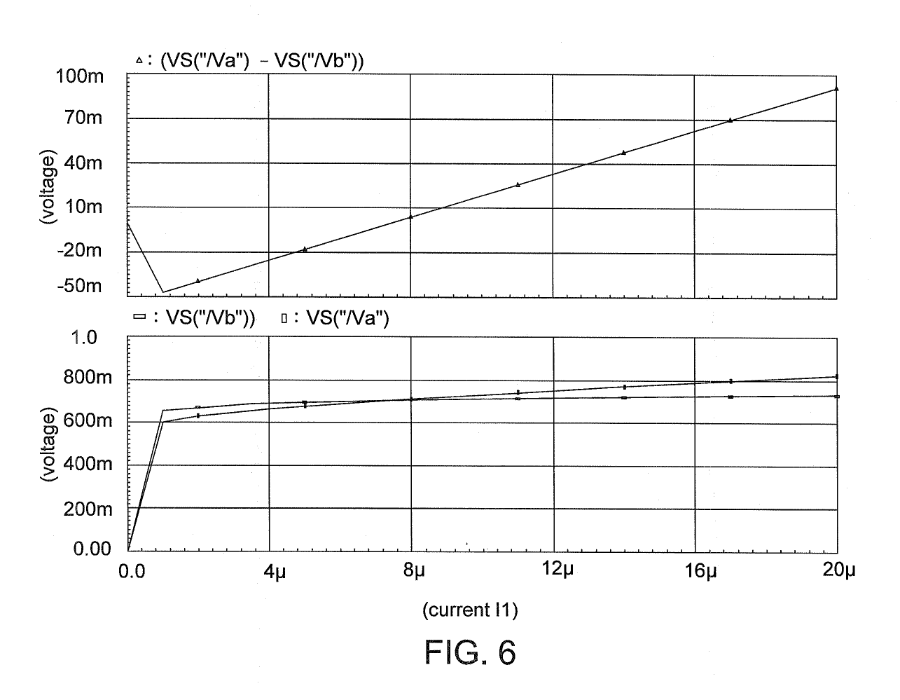

Please refer to FIG. 6, which shows a diagram a simulation experiment result of the reference voltage generator shown in FIG. 2. As shown in FIG. 6, the upper chart shows the difference between the voltages Va, Vb at the input ends of the first operational amplifier OP1 and the lower chart shows respective voltage values of the two input ends. The voltage indicated by Vb in FIG. 6 corresponds to the voltage indicated by Vbe in FIG. 5.

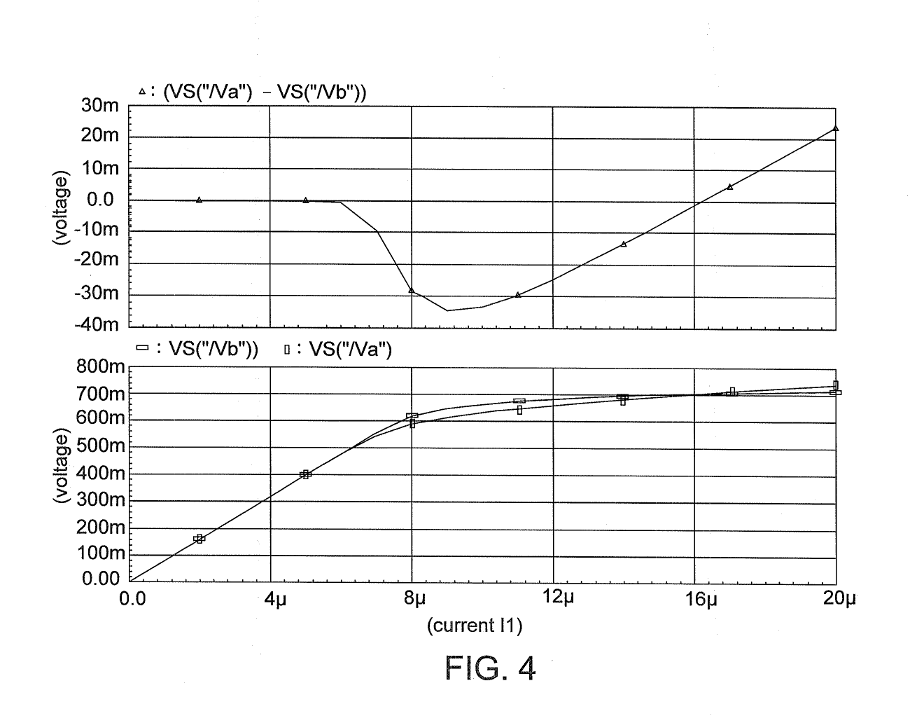

As similarly shown in FIG. 4, the balance statuses is when I1=0 μA and I1=7 μA. However, the difference between the voltages Va, Vb is larger (shown in the lower chart). Accordingly, the undesired balance status due to offset voltage of the first operational amplifier OP1 barely can occur. The reason is that unlike the reference voltage generator according to prior art, the reference voltage generator of the present invention does not utilize the series resistors R1a, R1b, R2a, R2b. Under general circumstances, the offset voltage of the first operational amplifier OP is only several mV (milli vols).

Although FIG. 6 and the aforementioned explanation are mainly compared with the band gap reference voltage generator of prior art shown in FIG. 2. However, the circuit of FIG. 2 is same as the thermal voltage generation circuit 510 of the present invention. The related technologies can be applied to the present invention.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A band gap reference voltage generator, comprising:
a thermal voltage generating circuit, providing a first voltage for generating a current component increased with temperature raising and a second voltage for generating a current component decreased with the temperature raising;
a voltage level optimizing circuit, optimizing a voltage level of the second voltage to generate a third voltage; and
a band gap reference voltage generating circuit, generating a reference voltage with a specific voltage level corresponding to the first voltage and the third voltage irrelevant with the temperature.

2. The band gap reference voltage generator of claim 1, wherein the thermal voltage generating circuit further comprises:
a first MOSFET, having one end coupled to a first power supply and a gate applied with the first voltage;
a second MOSFET, having one end coupled to the first power supply and generating the second voltage at the other end of the second MOSFET corresponding to the first voltage applied to the gate of the second MOSFET;
a first operational amplifier, having one end coupled to the other end of the first MOSFET and the other end coupled to the other end of the second MOSFET to generate the first voltage;
a first resistor, having one end coupled to the one end of the first operational amplifier;
a first bipolar transistor, having one end coupled to the other end of the first resistor and the other end coupled to a second power supply with the base terminal of the first bipolar transistor; and
a second bipolar transistor, having one end coupled to the other end of first operational amplifier and the other end coupled to the second power supply with the base of the second bipolar transistor,
wherein a size of the first bipolar transistor is m times of a size of the second bipolar transistor.

3. The band gap reference voltage generator of claim 1, wherein the voltage level optimizing circuit further comprises:
a second operational amplifier, outputting the third voltage corresponding to the second voltage applied to one end of the second operational amplifier;
a third MOSFET, having one end coupled to a first power supply, the other end coupled to the other end of the second operational amplifier and a gate applied with the third voltage; and
a third resistor, having one end coupled to the other end of the third MOSFET and the other end coupled to a second power supply.

4. The band gap reference voltage generator of claim 1, wherein the band gap reference voltage generating circuit further comprises:
a fourth MOSFET, having one end coupled to a first power supply and generating the reference voltage at the other end of the fourth MOSFET corresponding to the first voltage applied to the gate of the fourth MOSFET;
a fifth MOSFET, having one end coupled to the first power supply and generating the reference voltage at the other end of the fifth MOSFET corresponding to the third voltage applied to the gate of the fifth MOSFET; and
a second resistor, having one end coupled to the other end of the fourth MOSFET and the other end of the fifth MOSFET together and the other end coupled to a second power supply.
